(19) United States
(12) Patent Application Publication
(10) Pub. No.: US 2017/0267416 A1
(43) Pub. Date: Sep. 21, 2017

(54) A LID SHEET, A METHOD FOR MANUFACTURE, AND A PACKAGE

(71) Applicant: Danapak Flexibles A/S, Slagelse (DK)

(72) Inventors: Peter Lass Johansen, Odense (DK); Lars Christian Christensen, Slagelse (DK)

(21) Appl. No.: 15/532,077

(22) PCT Filed: Nov. 30, 2015
(86) PCT No.: PCT/DK2015/050364

§ 371 Date: May 31, 2017

(30) Foreign Application Priority Data
Dec. 2, 2014 (EP) 14195914.8
May 13, 2015 (EP) 15167635.0

(51) Int. Cl. B65D 43/02; B32B 27/32; B32B 27/36; B32B 37/15; B29C 65/00; B05D 7/04; B05D 7/24; B32B 38/04; B29C 65/02; B32B 27/08; B05D 5/00

(52) U.S. Cl. CPC B65D 43/02; B32B 27/08; B32B 27/32; B32B 27/36; B32B 37/153; B05D 5/00; B05D 7/04; B05D 7/24; B32B 38/04; B29C 65/02; B29C 66/02241; B29C 66/53461; B32B 2250/24; B32B 2255/10; B32B 2255/20; B32B 2307/31; B32B 2307/412; B32B 2307/7244; B32B 2439/40; B32B 2323/00; B32B 2323/10; B32B 2367/00; B32B 2038/042; B29L 2031/712

(57) ABSTRACT

The present disclosure relates to a transparent lid sheet for being punched to a transparent sheet lid to be attached to a container to produce a package, said lid sheet comprising: a transparent base layer, which comprises a transparent polyethylene terephtalate layer with a barrier layer coated onto the polyethylene terephtalate layer, the base layer having a first major surface, which preferably substantially coincides with an outer major surface of the barrier layer, and a top layer providing a welding layer for welding the sheet lid to the container, the top layer coinciding with the first major surface.

### CROSS-REFERENCE TO RELATED APPLICATIONS

This application is a 371 national phase filing of International Application No. PCT/DK2015/050364, entitled “A LID SHEET, A METHOD FOR MANUFACTURE, AND A PACKAGE”, filed 30 Nov. 2015, which claims priority to EP Patent Application No. 14195914.8, entitled “A LID SHEET, A METHOD FOR MANUFACTURE, AND A PACKAGE”, filed 2 Dec. 2014, and to EP Patent Application No. 15167635.0, entitled “A LID SHEET, A METHOD FOR MANUFACTURE, AND A PACKAGE”, filed 13 May 2015.

### BACKGROUND

The present invention relates to a transparent lid sheet for being punched to a transparent sheet lid to be attached to a container, specifically either a polyethyleneterephtalate (PET), a polypropylene (PP) or a polystyrene (PS) container or a container comprising either a polyethyleneterephtalate, a polypropylene or a polystyrene surface layer, to produce a package. The invention also relates to a method for manufacture of such a lid sheet as well as a package comprising such a lid sheet.

Lid sheets of various materials and compositions are known and are used as lids on containers producing packages, e.g. cups and bottles, for the packaging of especially milk products, fruit juices, drinking water, salads, pätés, etc. The lid may be made of an A1 sheet, to which a layer of welding lacquer has been applied in order for it to be able to adhere to the package. This type of lid, however, is not transparent, which is a widespread wish among consumers.

WO 2013/075713 A1 discloses a transparent lid sheet comprising a transparent polyethyleneterephtalate base layer coated with an additional layer on top of the base layer in the form of a polyolefin layer and a polyethyleneterephtalate welding layer of amorphous polyester, which are coextruded onto the base layer, the polyolefin layer being disposed between the base layer and the welding layer.

WO 2011/160627 A1 discloses a transparent lid sheet comprising a transparent polyethyleneterephtalate base layer coated with an additional layer on top of the base layer in the form of a polyolefin layer and a polypropylene welding layer, which are coextruded onto the base layer, the polyolefin layer being disposed between the base layer and the welding layer.

It is also known to apply a layer of non-transparent welding lacquer onto a transparent polyethyleneterephtalate sheet to produce a transparent sheet lid. Since the welding lacquer is milky, to achieve transparency of the sheet lid of the resultant package the welding lacquer is applied only to a welding area at the rim of the lid where the welding to the lid to the container is to take place. The welding lacquer has to be applied precisely, either to the punched lids or in an assembled form to a web of sheet in connection with the closure of the package. The welding lacquer thus leaves a visible rim along the lid edge.

On this background it is the object of the present invention to provide a lid sheet according to the introduction, which has improved barrier properties while retaining the advantageous qualities of the prior art lid sheets, including especially transparency, weldability and peelability.

### SUMMARY

This object is arrived at by the lid sheet, the method and the package according to the present invention.

Thus, the lid sheet according to the present invention comprises a transparent base layer, which comprises a transparent polyethyleneterephtalate layer with a transparent barrier coating or barrier layer coated onto the polyethyleneterephtalate layer, the base layer having a first major surface, which preferably substantially coincides with an outer major surface of the barrier coating, and a top layer providing a welding layer for welding the sheet lid to the container, the top layer preferably being provided at or coinciding with the first major surface.

Similarly, the method according to the present invention for manufacture of a transparent lid sheet comprises the steps of providing a transparent base layer, which comprises a transparent polyethyleneterephtalate layer with a transparent barrier coating or barrier layer provided directly onto the polyethyleneterephtalate layer, the base layer having a first major surface, which preferably substantially coincides with an outer major surface of the barrier coating, and coating a top layer at the first major surface, to provide a welding layer for welding the sheet lid to the container.

The package according to the present invention comprises a polyethyleneterephtalate, a polypropylene or a polystyrene container or a container comprising a polyethyleneterephtalate, a polypropylene or a polystyrene surface layer, and a sheet lid punched from a lid sheet according to the invention or manufactured according to the method according to the invention, the sheet lid being welded to the container along a welding area, specifically welding seems, at a rim of the container with the welding layer facing and adhering to the container, the sheet lid being separable from the container to open the package by grabbing and pulling at a periphery of the sheet lid causing part or all of the welding layer to remain on the container in the welding area, the welding layer delaminating from the remaining layers of the lid substantially in the welding area only.

It is preferred that the top layer is coated or disposed at or on the first major surface of the base layer, i.e. at or on the surface of the barrier coating (the expressions “at or on” and “at or onto” as used herein generally indicating that a further layer may or may not be present between the two layers). This provides protection of the barrier coating, which may otherwise be scratched, worn or destroyed if it is positioned on the opposite side, i.e. the side exposed outwardly when the sheet lid is positioned on the container. Thus, it is preferred that the barrier coating is covered and protected by the top layer.

The lid sheet manufactured according to the method according to the invention and the lid sheet according to the invention are generally transparent. All layers of the lid sheet are thus transparent except in the case where a welding lacquer is applied to a welding area of the lid sheet in which case the welding lacquer may not be transparent.

It is noted that in the context of the present specification the term “transparent” is intended to mean that when the lid sheet is applied as a lid of a container, it has an optical transparency high enough to allow the contents of the resultant package to be visually inspected. Generally, it is preferred that the transparency is at least 40%, more preferred at least 60%, and most preferred at least 70, 80, 90 or 95%, meaning that a corresponding amount of visible light is transferred through the sheet.

The base layer of the lid sheet according to the invention comprises a transparent polyethyleneterephtalate layer, which preferably essentially consists of polyethyleneterephtalate. The polyethyleneterephtalate layer may comprise small amounts of additional materials such as anti block agents, release agents and the like.

According to the invention it has surprisingly been found that a transparent lid sheet with extremely good barrier properties can be manufactured according to the invention, the lid sheet being weldable onto a container using a welding layer provided at a base layer comprising a barrier coating.

Moreover, the lid sheet surprisingly can be manufactured with sufficient adherence between the base and top layers, while peeling functionality during opening of a package with a lid sheet according to the invention is comparable to that of the prior art.

Furthermore, with the invention a lid sheet with superior barrier properties can be manufactured at surprisingly low cost.

The lid sheet according to the invention is especially suitable for sheet lids of packages used for foods or beverages, which are otherwise susceptible to adapt taste or smell from the packaging material. Examples of such foods or beverages are water, juice, milk or the like.

In addition, the base layer and welding layer show high resistance to fats and oils, and will thus be suitable for use in connection with foods and/or beverages containing fat, e.g. milk, yoghurts, cheese, salads, pâtés or the like.

A further layer in the form of a protection layer coated onto the barrier coating may be provided directly coated onto the first major surface to form part of the base layer, the first major surface being the top major surface of the protection layer. This protection layer may serve to protect the barrier coating, which is specifically relevant in the case of a ceramic barrier coating, and may have a thickness of up to 1.5 μm.

The base layer with barrier coating and potentially a protection layer may be manufactured in a first, separate process before the remaining layers of the lid sheet are produced.

In an embodiment of the lid sheet according to the invention a primer layer is provided between and on said first major surface and said top layer, the primer layer essentially consisting of a primer, which improves adherence of the top layer to said first major surface, the primer layer preferably being distributed with an amount of between 0.2 to 3.0 g/m2, more preferred 0.5 to 1.5 g/m2.

In a particularly advantageous development of this embodiment the primer layer essentially consisting of a substantially water-insoluble primer, the primer preferably being selected from the group consisting of: a polyurethane (PU) based primer, preferably with reactive isocyanate groups, a polyurethane/polyvinyl buthylene (PvB) based primer, a polyurethane/nitrocellulose (NC) based primer, and a hotmelt primer based on UV hardening technology. Other primer types may also be suitable.

During manufacture the primer layer may be applied directly onto said first major surface, the top layer subsequently being coated directly onto the primer layer.

The inventors have discovered that the primer should preferably be solvent based, i.e. non-soluble in water, since the high barrier properties of the ceramic barrier coating may lead to accumulation of water against the barrier coating, which may negatively influence especially the adhesiveness of the primer, potentially leading to the adjacent layers unintentionally being released.

A solvent based primer can comprise or essentially consist of one of the following commercially available products: Dow Adcote 76H5M-EA; Coim NC-3001-A; Coim CA-916 with hardener; and Siegwerk WG035

The use of a primer may be avoided if a polymer with a sufficiently high adhesion to the base layer is selected for the part of the top layer, which in this case is applied directly onto the base layer. In case the top layer is coextruded onto the base layer, such an adhesive polymer may be provided by coextruding it directly onto the further coextruded layer(s) of the top layer.

The enhanced adhesion between the base layer and the top layer achieved by using a primer layer allows delamination to be controlled during opening of a package with a sheet lid punched from a lid sheet according to the invention.

In an embodiment the barrier coating essentially consists of either polyvinylidene chloride (PVdC) or a ceramic barrier material selected from the group consisting of aluminium oxide (AlOx), silicium oxide (SiOx), magnesium oxide, cerium oxide, hafnium oxide, tantalum oxide, titanium oxide, yttrium oxide, zirconium oxide and mixtures thereof.

Whereas the oxygen transmission rate (ASTM D3985, 23° C., 0% RH) in the above prior art lid sheets comprising a polyethyleneterephtalate base layer has a magnitude in a range of typically 30 to 50 cm3/m2/24 h/bar, with a lid sheet according to this embodiment the oxygen transmission rate with similar thickness of the base layer is typically in the range of less than 1 to 10 cm3/m2/24 h/bar. A typical desired maximum oxygen transmission rate in lid sheets is 7 to 10 cm3/m2/24 h/bar.

Similarly, whereas water vapour transmission rate (ASTM F1249, 38° C., 90% RH) in the above prior art lid sheets has a magnitude in a range of typically 10 to 20 g/m2/24 h, with a lid sheet according to the present embodiment the water vapour transmission rate with similar thickness of the base layer is typically in the range of less than 1 to 10 g/m2/24 h.

The above mentioned primer materials are specifically suitable for being applied to the barrier materials of the present embodiment, i.e. the materials of the polyvinylidene chloride barrier coating or ceramic barrier coating.

The polyvinylidene chloride barrier coating or ceramic barrier coating may have a thickness of less than 1.5 μm, preferably less than 1.2 μm, more preferred less than 1 μm, and preferably of more than 0.05 μm, more preferred more than 0.5 μm. With a barrier coating thickness of less than 1 μm an oxygen transmission rate of the lid sheet of less than 3 cm3/m2/24 h/bar can be achieved. Similarly, a water vapour transmission rate of less than 3 g/m2/24 h can be achieved.

In an embodiment the base layer has a thickness of between 23 and 60 μm.

In an embodiment the top layer comprises, preferably consists of, a polyolefin layer and either a) a polyethyleneterephtalate welding layer of polyethyleneterephtalate, preferably amorphous polyethyleneterephtalate (APET) and/or polyethyleneterephtalate glycol-modified (PETG), or b) a polypropylene welding layer coated at, preferably directly on, the base layer, the polyolefin layer being disposed between the base layer and the welding layer. This provides a peelable top layer where the polyolefin layer and the remaining parts of the lid sheet in a welding area can be peeled off from the welding layer when opening a package provided with a sheet lid manufactured from the lid sheet.

During manufacture the top layer is preferably coated at or onto said first major surface by coextruding the polyolefin layer and the polyethyleneterephtalate or polypropylene welding layer at or onto said first major surface.

The top layer is hereby transparent, overall transparency of the lid sheet being maintained so that the welding layer can be provided across the entire surface of the lid sheet, which lowers production costs.

Additionally, the coextruded layer on top of the base layer ensures that the punched lid possesses a suitable rigidity, which prevents the lid from curling, thereby making it possible to punch lids and to apply pre-punched lids to the containers.

A printing process for applying a welding lacquer is avoided in this embodiment.

In addition, in the case where the welding layer is a polyethyleneterephtalate welding layer, the welding layer may have superior organoleptic properties when compared to a polypropylene welding layer since it is less likely to transfer taste to the food or beverage in the package.

Coextrusion of the top layer has the effect that the lid sheet is stronger than a corresponding one provided with welding lacquer, thereby allowing the thickness of the polyethyleneterephtalate layer of the base layer to be reduced correspondingly, which may achieve saving of weight and material of about 15% compared to a solution using welding lacquer. In this embodiment the base layer preferably has a thickness 23 to 50 um, more preferred 30 to 40 um.

The polyolefin layer may be a polyethylene layer, preferably in the form of a homopolymer or a copolymer of polyethylene, such as an acrylic polyethylene polymer or an ethyl vinyl acetate (EVA) containing polyethylene or mixtures thereof.

If a polyethyleneterephtalate welding layer is used, this layer is optionally made of polyethyleneterephtalate glycol-modified, since polyethyleneterephtalate glycol-modified generally does not crystallize. This results in a welding layer with improved welding properties, e.g. when welding at temperatures below 230° C., compared to normal polyethyleneterephtalate, which may lose its welding properties when it crystallizes.

When the welding layer is disposed against the welding rim surface of the container of polyethyleneterephtalate (in the case where a polyethyleneterephtalate welding layer is used) or polypropylene (in the case where a polypropylene welding layer is used), respectively, safe fusion and thereby tightly fitting assembly of lid and container are achieved.

The coextruded top layer is preferably distributed with an amount of between 10 to 22 g/m2, preferably 12 to 17 g/m2.

In an embodiment alternative to the latter embodiment (using a top layer including a polyolefin layer and a welding layer that may be coextruded at or onto the base layer) the top layer is a potentially non-transparent lacquer welding layer positioned on or at said first major surface substantially only in a welding area of the lid sheet corresponding to a welding rim of the container.

The lacquer may be a polyethyleneterephtalate lacquer (i.e. not necessarily based on polyester, but suitable for welding to a polyethyleneterephtalate container) or a combi lacquer suitable for welding to a polypropylene or polystyrene container.

During manufacture the top layer may be coated at or onto the barrier coating, the welding lacquer preferably being applied by means of gravure, such as rotogravure, or plain roller, preferably dried at 200° to 240° C., typically 220° C. to 230° C.

When using a welding lacquer, to achieve suitable strength of the lid sheet a base layer with a thickness of 40 μm to 60 μm, typically about 50 μm, may be used.

The welding lacquer layer may be distributed with an amount of 4 to 8 g/m2, preferably 5 to 7 g/m2.

In an embodiment the method according to the invention also comprises the further the step of punching the lid sheet to the final shape of a sheet lid, and subsequently welding the sheet lid to the container, the welding layer facing and adhering to the container in a welding area of the lid along a rim of the container such as to produce a closed package.

In a development of the latter method the closed package is opened by grabbing and pulling at a periphery of the sheet lid to separate the sheet lid from the package so that the welding layer substantially remains on the container in the welding area, the welding layer delaminating from the remaining layers of the sheet lid substantially in the welding area only.

Thus, a pull in a corner, flap or tap of the lid may cause the welding layer to remain on the container in the welding area as the welding layer and the remaining parts of the lid sheet delaminate substantially in the welding area only. This ensures that when the lid is pulled off the container, a precise peeling or delamination of the welding layer will take place, thereby ensuring that the sheet lid is pulled off without the lid being torn or destroyed.

### BRIEF DESCRIPTION OF THE DRAWINGS

Embodiments of the invention will be described in the following detailed description with reference to the drawings.

FIG. 1 shows a perspective view of an embodiment of a package according to the invention manufactured according to the method according to the invention comprising a container and a sheet lid manufactured from a lid sheet according to an embodiment of the invention, the package being shown prior to welding;

FIG. 2 shows a detail of the package of FIG. 1 in a sectional view taken along the line II-II in FIG. 1 after the sheet lid has been torn off of the container, i.e. after delamination;

FIG. 3 shows a schematic sectional view of the lid sheet of FIG. 1 before delamination;

FIG. 4 shows a schematic sectional view corresponding to that of FIG. 3 of an alternative embodiment of the lid sheet according to the invention before delamination; and

FIG. 5 shows a schematic sectional view corresponding to that of FIG. 3 of an alternative embodiment of the lid sheet according to the invention before delamination.

### DETAILED DESCRIPTION

In this specification, generally when terms such as “thickness” (unit um) and “distribution” (unit g/m2) are used, unless otherwise indicated it is to be understood that the layer in question has a substantially or essentially uniform thickness across the planar extent of the layer or sheet according to the provided value.

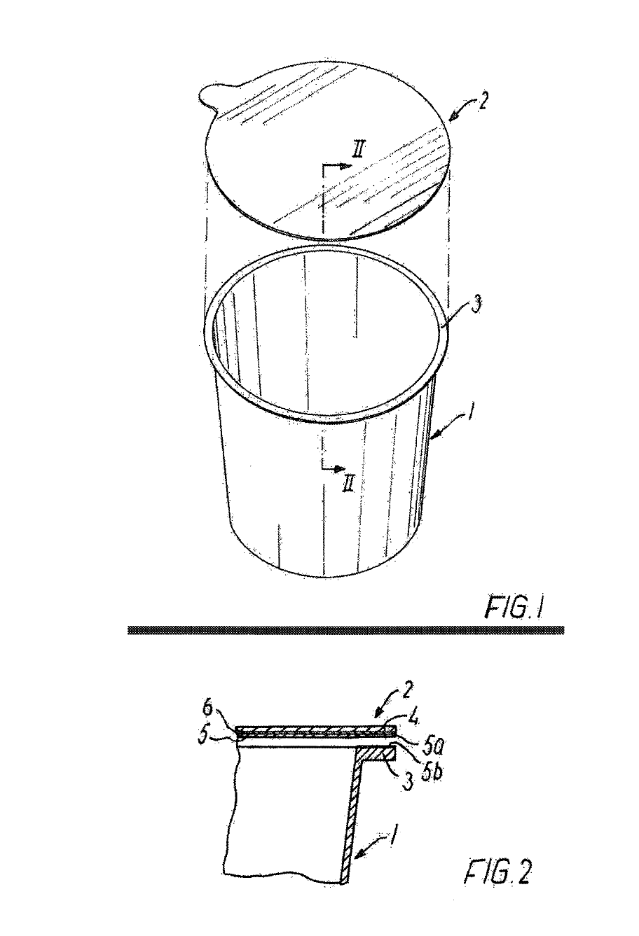

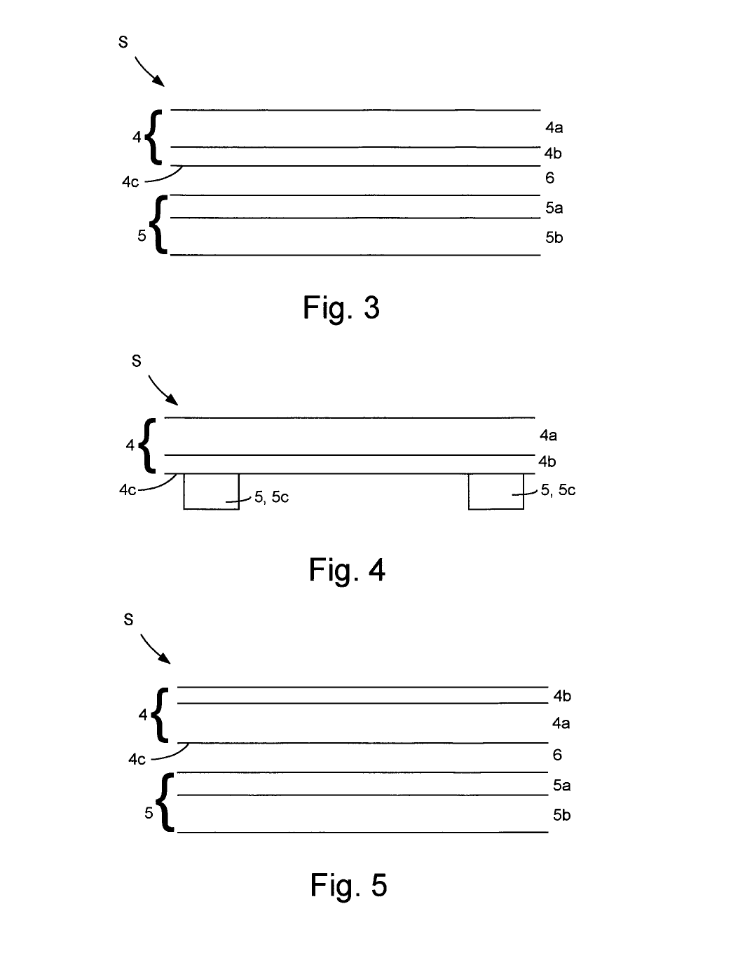

The package shown in FIGS. 1 and 2 comprises a container 1, which is manufactured of polyethyleneterephtalate, such as amorphous polyester or crystalline polyester (CPET), or polypropylene. The package comprises a sheet lid 2 punched from the lid sheet S shown in FIG. 3, the lid 2 in FIGS. 1 and 2 being shown in a position prior to welding.

Especially in the case where the container 1 is made of polyethyleneterephtalate the package is specifically suitable for packaging of water, fruit juices, salads or like products. Especially in the case where the container 1 is made of polypropylene the package is specifically suitable for packaging of yoghurt or like milk products. In both cases the container 1 may also be a tray or the like for salad foods or a bottle for milk or soft drinks.

The container 1 is provided with an upper welding rim 3, which is plane on an upper side, which faces the sheet lid 2, to enable welding of the sheet lid 2 onto the rim 3 to produce the closed package.

When the container 1 has been filled with its contents, it is closed with the sheet lid 2. The lid 2 has been punched in advance and is thus adapted in shape and size to the opening of the container 1 before welding.

The lid sheet S and thus the punched lid 2 comprises a transparent base layer 4 with a transparent polyethyleneterephtalate top layer 4a, which has a thickness of between 23 and 50 μm, preferably a thickness of 30-40 μm. This thickness is adapted to the need for strength, barrier properties, size, etc. The polyethyleneterephtalate layer 4a is essentially constituted of polyethyleneterephtalate. The base layer 4 also comprises a barrier coating 4b coated onto the polyethyleneterephtalate layer 4a, see FIG. 3.

On this base layer 4 a top layer comprising a polyolefin layer, specifically a polyethylene layer, which is designated 5a, and either a polyethyleneterephtalate welding layer or a welding layer comprising a polypropylene polymer, which is designated 5b, is provided by coextrusion of the two layers 5a and 5b directly onto a first major surface 4c of the polyethyleneterephtalate base layer 4. The welding layer 5b is intended to be welded together with the rim portion 3 of the container 1.

The polyolefin layer 5a is a homopolymer or a copolymer of polyethylene—a suitable polyethylene copolymer is an acrylic copolymer of polyethylene or an ethyl vinyl acetate containing polyethylene—and will be denoted the polyethylene layer in the following. Use of any of these copolymers ensures that delamination between the welding layer 5b and the polyethylene layer 5a only occurs in the welding area.

In the case where the welding layer 5b is a polyethyleneterephtalate welding layer, the welding layer may be or comprise a homopolymer or a copolymer of polyethyleneterephtalate. It may comprise other polymers, additives etc., but preferably mainly comprises polyethyleneterephtalate. A highly suitable material for the welding layer is polyethyleneterephtalate glycol-modified, a pure polyester which does not crystallize, i.e. it remains amorphous. This results in a welding layer with improved welding properties in contrast to normal polyester, which loses its welding properties when it crystallizes at temperatures well below 220 to 230° C., which is the maximum temperature level for sealing, due to the softening point of the base layer 4.

In the case where the welding layer 5b is a polypropylene welding layer, the welding layer may be or comprise a homopolymer or a copolymer of polypropylene. It may comprise other polymers, additives etc., but preferably mainly comprises polypropylene. A suitable copolymer of the polypropylene welding layer may contain polyethylene.

The two layers 5a and 5b are preferably distributed in an accumulated amount of about 12 to 22 g/m2, preferably 15 to 17 g/m2. The polyethylene layer 5a preferably has a thickness of 5 to 15 g/m2, corresponding to about 5.5 to 17 μm. In the case were a polyethyleneterephtalate welding layer is used, the welding layer 5b preferably has a thickness of 2 to 10 g/m2, corresponding to about 2.8 to 7.5 μm. In the case where a polypropylene welding layer 5b is used, the polypropylene welding layer 5b is preferably distributed in an amount of about 4 to 6 g/m2 corresponding to about 4.3 to 6.5 μm.

The base layer 4 has applied thereto a primer layer 6, which ensures enhanced adhesion between the first major surface 4c of the base layer 4 and the polyethylene layer 5a.

An alternative method of manufacture of a lid sheet according to the invention comprises extrusion of the base layer 4 and, by coextrusion, the creation of the layer 5 by a first layer 5a and a welding layer 5b, said layers 4, 5 being put together to form the lid sheet S.

It is preferred that the lid sheet S is calendered immediately after the application of the coextruded layer to the base layer.

The resultant lid sheet S is transparent and weldable in its full planar extent. Thereby, any lid shape and dimension may be punched from a roll of lid sheet, as the resultant lid 2 may be adapted to the size and shape of the container 1. The lid 2 is supplied from a roll of the lid sheet S and is punched into its final shape prior to being applied to the containers 1.

In connection with the filling of containers, e.g. cups, in a filling machine, the lid 2, preferably pre-punched into its final shape, is applied subsequently and welded to the rim portion 3.

When the container 1 has thus been filled and closed with the sheet lid 2, the user will be able to pull off the lid 2 by pulling in a periphery of the sheet lid 2, specifically in a lid flap or lid tap visible in FIG. 1.

Hereby, the polyethylene layer 5a and the welding layer 5b will be sepa-rated or delaminated from each other in such a manner that the pulling-off or opening of the package along the rim portion 3 is controlled and precise. The welding layer 5b will essentially remain on the container 1 in the welding area, i.e. on the rim portion 3 thereof, and remain on the lid 2 in the non-welded area.

Since the two layers 5a and 5b are relatively stiff, the dimensions of the base layer 4 may be reduced, thus saving weight as well as consumption of material. Moreover, as a result of the enhanced rigidity of the lid sheet, the punched lid 2 does not curl after the punching.

Optionally, an additional print or colour layer may be applied in a generally known manner on for example a top surface or a bottom surface of the sheet lid 2 either before or after the punching of the lid 2, and/or an additional barrier coating may optionally be applied to the lid sheet before or after the coating and/or punching.

FIG. 4 is a view similar to that of FIG. 3 showing an alternative embodiment of the lid sheet S according to the invention. This lid sheet S is generally similar to the embodiment of the lid sheet S shown in FIGS. 1 to 3 except for the differences mentioned in the following.

Thus, in the embodiment of FIG. 4 the top layer 5 is a non-transparent lacquer welding layer 5c coated onto the major surface 4c substantially only in a welding area of the lid sheet S corresponding to the welding rim 3 of the container 1. On the remaining parts of the major surface 4c no lacquer or any other layer is present, i.e. the surface of the sheet lid 2 facing the contents of the container 1 is the major surface 4c of the base layer 4.

A fully covering transparent lacquer (not shown) may optionally be applied on the first major surface 4c before the welding lacquer layer 5c is applied.

The lid sheet S shown in FIG. 4 may be applied to a similar container 1 as shown in FIGS. 1 and 2. If the container 1 is a polyethyleneterephtalate container, a polyethyleneterephtalate welding lacquer is applied. If the container 1 is a polypropylene or polystyrene container a combi welding lacquer is applied.

During manufacture the top layer 5 is coated onto the barrier coating 4b by means of rotogravure and dried at 220° C. to 230° C. The top layer 5 is distributed with an amount of 6 g/m2.

FIG. 5 shows an embodiment of the lid sheet according to the invention, which is similar to that of FIG. 3 with the only difference being that the barrier coating 4b is positioned on the opposite side of the lid sheet S so that the barrier coating 4b faces away from the lid sheet S. As is shown, the top layer 5 is coated on the surface 4c of the polyethyleneterephtalate layer 4a of the base layer 4 via a primer layer 6. The primer layer 6 can be composed of a primer similar to the primer applied in the embodiment of FIG. 3.

Generally, in the lid sheets S and the sheet lids 2 described above the layers are preferably provided extending substantially along the entire area of the adjacent layer so that the area sizes of major surfaces of all layers are similar to each other. However, specifically in the embodiment where the top layer 5 is a lacquer welding layer 5c the top layer 5 substantially only extends in or at a welding area.

### Example 1: Lid Sheets According to the Prior Art

A lid sheet was prepared according to WO 2013/075713 A1 with a polyethyleneterephtalate base layer with a thickness of 36 μm coated with an additional layer or top layer with a thickness of 16 g/m2 on top of the base layer in the form of a polyolefin layer and a polyethyleneterephtalate welding layer of amorphous polyester, coextruded onto the base layer, the polyolefin layer being disposed between the base layer and the welding layer.

A further lid sheet was prepared according to WO 2011/160627 A1 with a polyethyleneterephtalate base layer with a thickness of 36 μm coated with an additional layer or top layer with a thickness of 16 g/m2 on top of the base layer in the form of a polyolefin layer and a polypropylene welding layer, coextruded onto the base layer, the polyolefin layer being disposed between the base layer and the welding layer.

In both cases the oxygen transmission rate (ASTM D3985, 23° C., 0% RH) was measured to approximately 45 cm3/m2/24 h/bar. The water vapour transmission rate (ASTM F1249, 38° C., 90% RH) was approximately 15 g/m2/24 h.

A further lid sheet was prepared by coating a non-transparent 6 g/m2 top layer welding lacquer onto a 50 μm transparent polyethylene terephtalate sheet only at a welding area at a rim of the lid.

In this case the oxygen transmission rate (ASTM D3985, 23° C., 0% RH) was measured to approximately 35 cm3/m2/24 h/bar. The water vapour transmission rate (ASTM F1249, 38° C., 90% RH) was approximately 12 g/m2/24 h.

The difference in the transmission rates is believed to mainly be due to the different thicknesses of the base layers.

### Example 2: Lid Sheets According to the Invention Applying a Coextruded Top Layer

A transparent lid sheet was prepared according to the embodiment described above with reference to FIGS. 1 to 3 using a base layer with a thickness of 36 μm coated with a top layer with a thickness of 16 g/m2 on top of the base layer in the form of a polyolefin layer and a polyethylene terephtalate welding layer, coextruded onto the base layer, the polyolefin layer being disposed between the base layer and the welding layer. The base layer comprised a transparent polyethylene terephtalate layer with a transparent<1 μm aluminium oxide barrier coating and a 1 μm protective layer applied directly onto the polyethylene terephtalate layer. A 1 μm water-insoluble primer was applied between the top and base layers.

A further transparent lid sheet was prepared according to the embodiment described above with reference to FIGS. 1 to 3 using a base layer with a thickness of 36 μm coated with a top layer with a thickness of 16 g/m2 on top of the base layer in the form of a polyolefin layer and a polypropylene welding layer, coextruded onto the base layer, the polyolefin layer being disposed between the base layer and the welding layer. The base layer comprised a transparent polyethylene terephtalate layer with a transparent<1 μm aluminium oxide barrier coating and a 1 μm protective layer applied directly onto the polyethylene terephtalate layer. A 1 μm water-insoluble primer was applied between the top and base layers.

In both cases the oxygen transmission rate (ASTM D3985, 23° C., 0% RH) was measured to approximately 1-3 cm3/m2/24 h/bar. The water vapour transmission rate (ASTM F1249, 38° C., 90% RH) was approximately 1-3 g/m2/24 h.

A further transparent lid sheet was prepared according to the embodiment described above with reference to FIGS. 1 to 3 using a base layer with a thickness of 36 μm coated with a top layer with a thickness of 16 g/m2 on top of the base layer in the form of a polyolefin layer and a polypropylene welding layer, coextruded onto the base layer, the polyolefin layer being disposed between the base layer and the welding layer. The base layer comprised a transparent polyethylene terephtalate layer with a transparent 1 μm polyvinylidene chloride barrier coating and a 1 μm protective layer applied directly onto the polyethylene terephtalate layer. A 1 μm water-insoluble primer was applied between the top and base layers.

In this latter case the oxygen transmission rate (ASTM D3985, 23° C., 0% RH) was measured to approximately about 8 cm3/m2/24 h/bar. The water vapour transmission rate (ASTM F1249, 38° C., 90% RH) was approximately 8 g/m2/24 h.

### Example 3: Lid Sheets According to the Invention Applying a Welding Lacquer Top Layer

A transparent lid sheet was prepared according to the embodiment described above with reference to FIG. 4 using a base layer with a thickness of 50 μm coated with a top layer with a thickness of 6 g/m2 on top of the base layer in the form of a polyethylene terephtalate lacquer welding layer. The base layer comprised a transparent polyethylene terephtalate layer with a transparent<1 μm aluminium oxide barrier coating and a <1 μm protective layer applied directly onto the polyethylene terephtalate layer.

A further transparent lid sheet was prepared according to the embodiment described above with reference to FIG. 4 using a base layer with a thickness of 50 μm coated with a top layer with a thickness of 6 g/m2 on top of the base layer in the form of a combi lacquer welding layer. The base layer comprised a transparent polyethylene terephtalate layer with a transparent <1 μm aluminium oxide barrier coating and a 1 μm protective layer applied directly onto the polyethylene terephtalate layer.

In both cases the oxygen transmission rate (ASTM D3985, 23° C., 0% RH) was measured to approximately 1-3 cm3/m2/24 h/bar. The water vapour transmission rate (ASTM F1249, 38° C., 90% RH) was approximately 1-3 g/m2/24 h.

A further transparent lid sheet was prepared according to the embodiment described above with reference to FIG. 4 using a base layer with a thickness of 50 μm coated with a top layer with a thickness of 6 g/m2 on top of the base layer in the form of a combi lacquer welding layer. The base layer comprised a transparent polyethylene terephtalate layer with a transparent<1 μm polyvinylidene chloride barrier coating and a 1 μm protective layer applied directly onto the polyethylene terephtalate layer.

In this latter case the oxygen transmission rate (ASTM D3985, 23° C., 0% RH) was measured to approximately 8 cm3/m2/24 h/bar. The water vapour transmission rate (ASTM F1249, 38° C., 90% RH) was approximately 8 g/m2/24 h.

It appears from the examples that when using a barrier coating the thickness of the polyethylene terephtalate layer of the base layer is not decisive for the barrier properties.

What is claimed is:

1-19. (canceled)

20. A transparent lid sheet for being punched to a transparent sheet lid to be attached to a container to produce a package, said transparent lid sheet comprising:
a transparent base layer, which comprises a transparent polyethylene terephtalate layer with a transparent barrier layer coated onto the transparent polyethylene terephtalate layer, the transparent base layer having a first major surface, which preferably substantially coincides with an outer major surface of the transparent barrier layer, and
a top layer providing a welding layer for welding the transparent sheet lid to the container, the top layer coinciding with the first major surface.

21. The transparent lid sheet of claim 20, wherein said container is specifically a polyethylene terephtalate container.

22. The transparent lid sheet of claim 20, wherein said container is specifically a container comprising a polyethylene terephtalate surface layer.

23. The transparent lid sheet of claim 20, wherein said transparent barrier layer is an oxygen barrier layer.

24. The transparent lid sheet of claim 20, wherein a primer layer is provided between said first major surface and said top layer, the primer layer essentially consisting of a primer, which improves adherence of the top layer to said first major surface.

25. The transparent lid sheet of claim 24, wherein the primer layer essentially consists of a substantially water-insoluble primer.

26. The transparent lid sheet of claim 20, wherein the transparent barrier layer essentially consists of polyvinylidene chloride selected from the group consisting of: aluminium oxide, silicium oxide, magnesium oxide, cerium oxide, hafnium oxide, tantalum oxide, titanium oxide, yttrium oxide, zirconium oxide and mixtures thereof.

27. The transparent lid sheet of claim 20, wherein the transparent barrier layer has a thickness of less than 1.5 μm.

28. The transparent lid sheet of claim 20, wherein the top layer comprises a polyolefin layer and a polyethylene terephtalate welding layer of polyethylene terephtalate coated at the transparent base layer, the polyolefin layer being disposed between the transparent base layer and the welding layer.

29. The transparent lid sheet of claim 20, wherein the top layer comprises a lacquer welding layer of a welding lacquer positioned at or on said first major surface substantially only in a welding area of the transparent lid sheet corresponding to a welding rim of the container.

30. A method for manufacture of a transparent lid sheet for being punched to a sheet lid to be attached to a container to produce a package, comprising the steps of:
providing a transparent base layer, which comprises a transparent polyethylene terephtalate layer with a transparent barrier layer provided directly onto the transparent polyethylene terephtalate layer, the transparent base layer having a first major surface, which preferably substantially coincides with an outer major surface of the transparent barrier layer, and
coating a top layer at or onto the first major surface to provide a welding layer for welding the sheet lid to the container.

31. The method of claim 30, wherein the container is specifically a polyethylene terephtalate container.

32. The method of claim 30, wherein said transparent barrier layer is an oxygen barrier layer.

33. The method of claim 30, further comprising the step of:
applying a primer layer onto said first major surface, the primer layer essentially consisting of a primer, which improves adherence of the top layer to said first major surface, the top layer subsequently being coated onto the primer layer.

34. The method of claim 30, wherein the top layer is coated at said first major surface by coextruding a polyolefin layer and a polyethylene terephtalate welding layer, at or onto said first major surface, the polyolefin layer being disposed between said first major surface and the welding layer.

35. The method of claim 30, wherein the top layer is coated onto the transparent barrier layer by applying a welding layer of a welding lacquer at or onto said first major surface to form a lacquer welding layer disposed substantially only in a welding area of the transparent lid sheet corresponding to a welding rim of the container.

36. The method of claim 30, wherein the resultant lid sheet comprises:
the transparent base layer comprising the transparent polyethylene terephtalate layer with the transparent barrier layer coated onto the transparent polyethylene terephtalate layer, the transparent base layer having the first major surface, which preferably substantially coincides with the outer major surface of the transparent barrier layer, and
the top layer providing the welding layer for welding the sheet lid to the container, the top layer coinciding with the first major surface.

37. The method of claim 36, wherein the top layer comprises a lacquer welding layer of a welding lacquer positioned at or on said first major surface substantially only in a welding area of the resultant lid sheet corresponding to a welding rim of the container.

38. The method of claim 30, further comprising the steps of
punching the transparent lid sheet to a final shape of the sheet lid, and subsequently
welding the sheet lid to the container, the welding layer facing and adhering to the container in a welding area of the sheet lid along a rim of the container such as to produce a closed package.

39. A package, comprising
a polyethylene terephtalate container;
a transparent sheet lid; and
a transparent lid sheet comprising:
a transparent base layer, which comprises a transparent polyethylene terephtalate layer with a barrier layer coated onto the transparent polyethylene terephtalate layer, the transparent base layer having a first major surface, which preferably substantially coincides with an outer major surface of the barrier layer, and
a top layer providing a welding layer for welding the transparent sheet lid to the polyethylene terephtalate container, the top layer coinciding with the first major surface, and the transparent sheet lid punched from the transparent lid sheet, the transparent sheet lid being welded to the polyethylene terephtalate container along a welding area, specifically welding seems, at a rim of the polyethylene terephtalate container with the welding layer facing and adhering to the polyethylene terephtalate container, the transparent sheet lid being separable from the polyethylene terephtalate container to open the package by grabbing and pulling at a periphery of the transparent sheet lid causing the welding layer to remain on the polyethylene terephtalate container in the welding area, the welding layer delaminating from the remaining layers of the transparent sheet lid substantially in the welding area only.
